(19) United States
(12) Patent Application Publication
(10) Pub. No.: US 2007/0030526 A1
(43) Pub. Date: Feb. 8, 2007

(54) Integrated multi-functional recognition device for use in public and private offices

(75) Inventors: Valerio Abate, Saronno (IT); Alberto Conti, Milano (IT); Michela Bianchi, Milano (IT)

Correspondence Address: BROWDY AND NEIMARK, P.L.L.C.;624 NINTH STREET, NW, SUITE 300, WASHINGTON, DC, 20001-5303, US

(73) Assignee: EASY INTERNATIONAL SRL, MILANO (IT)

(21) Appl. No.: 10/570,596

(22) PCT Filed: Jul. 15, 2004
(86) PCT No.: PCT/IT04/00389

§ 371 Date: Mar. 6, 2006

(30) Foreign Application Priority Data
Sep. 6, 2003 (WO) PCT/IT03/00534

(51) Int. Cl. H04N 1/40

(52) U.S. Cl. 358/448

(57) ABSTRACT

An integrated multi-function device comprising a processor electrically coupled to an input device operable by a user, a device for weighing items of postage, a device for capturing image, a visual display, a printing system, and a communication device. The processor is configured to receive input from the weighing device, the image capture and the input device. It processes and stores the image information captured, provides to the visual display output showing image, dimensions writings and all characteristic from an object placed the device.

This invention relates to an integrated multi-function desk for use in offices both private and public.

Office devices, public office devices and processes involving the use these devices are often source of errors due to reduction of human attention over time. Human attention is not constant over time and it is a qualitative distinction: its use in processes shall be controlled and carefully weighted.

On the contrary the occasional use of automatic devices such as automatic money dispenser etc. produce errors while great attention is dedicated to process operations due to novelty or uneven use. Often the realization of such devices produce a lack of space and difficult of use since they are added to an existing lay-out without proper integration in the available environment. All this produce negative impact on the operator and on the end-user producing a stress or bad impressions in the use of such devices.

Herein and in the following the notation of document is used intending any surface having a script, symbol, image or stamp on it visible surface OR ON THE OTHER SIDE. If the surface is related to a thick object such as a book, a box etc. the document includes the visible surface and its logic continuation on the other sides of the body.

Usually offices desktops surfaces and their neigh borrow volumes are filled with devices. Each devices specifically performs a function and requires both hardware interface and software (i.e. drivers) to the office processing unit or network bridge. In such a condition the need for a new functionality requires expanding the connecting capability of the office computer or adding a new intermediate device to allow interface port multiplication. Each device, requires a proper driver and they despite standards and regulation often interacts producing if not a malfunctions even performance reduction and greater memory need for the processing unit. New generation devices partially solve this problem but they do not have the possibility to reduce amount of communication signals and protocols common parts since they are not integrated devices. The effect is year by year the request for installation in processing unit of new ports, more memory etc. The disclosed device has a built in port multiplier, the system is thus able to guarantee the performances through a single port in the direction of the network and manages several existing integrated interfaces for each devices.

Usually offices needs for documents copies. The copies are a print-out of an electronic signal acquired by a scanning, processed internally and sent to printing module. Xerox machines and scanners, due to the typical mechanical layouts applied in the fields, are very complex and contains several components. The number of components and the mechanical concepts generated thereof, allow for a double faces image acquisition BUT the system requires page turning upside-down and often a special pattern or mechanism is inserted to allow this functionality. This often creates, in case of in-process stop for maintenance pause or malfunction, the difficulties of restarting the operation, inserting the last or earlier sheet and couple the new photocopies or digital images group. The disclosed devices use solid state CMOS data acquisition system on both side of the document to maintain reliable and simple image acquisition system. Using such a system double side image acquisition is much easier and more reliable.

Moreover the presence of a CCD array (as presented in U.S. Pat. No. 6,169,978) is not as advantageous as a static system because it is much more sensitive to mechanical wear but it allows better than CCD to move the scanning array vertically at the level of upper object surface giving two further advantages:

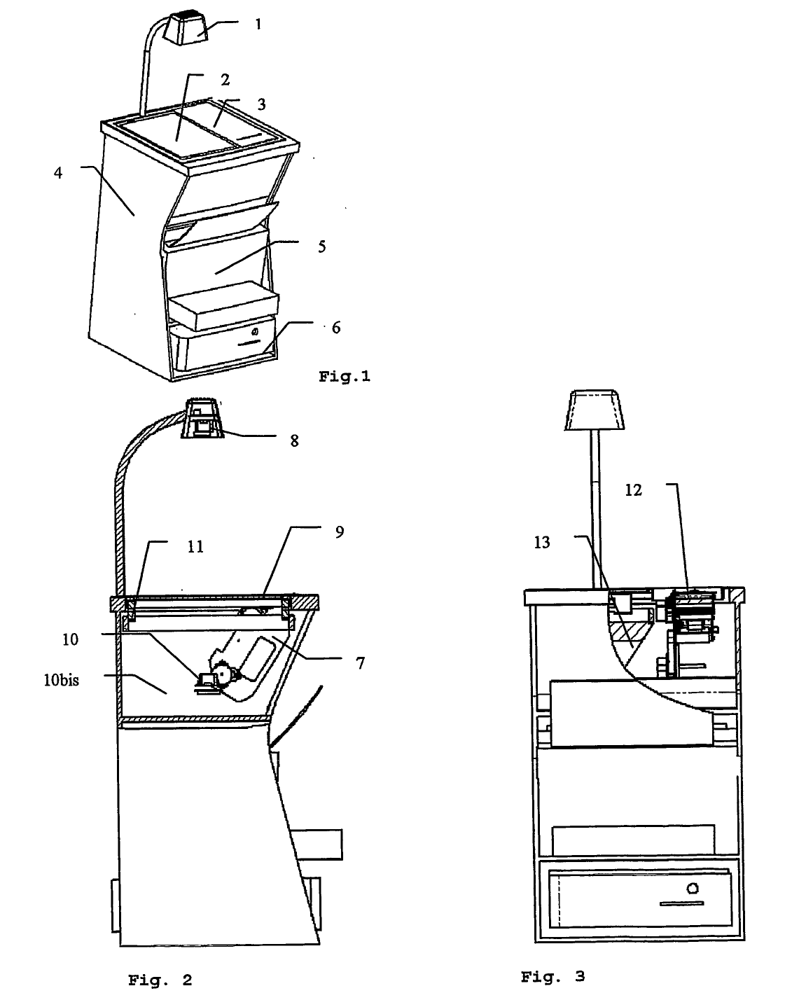

A direct measure of the height of the postal delivery that in case of CCD is obtained by comparison of the apparent deformation of a projected grid, a more perfect focusing of the image since the absolute depth variation is more contained. In FIGS. 1,2,3,4 is represented the layout of the system realized with a static image capturing system, the choice to realize the device using a movable image capturing is related to the life service life. Being a built in like block with local or remote electronics the proposed system is much more effective in MTBF parameters both for the MTBF of components and for the reduction in component number.

A further advantage of the proposed invention compared to U.S. Pat. No. 6,169,978 is that when the item is placed on the weighing plate there is no necessity to move the item, or align it better or further ancillary operation to have the weight, dimensions image etc. from the proposed invention.

A further advantage of the proposed invention compared to U.S. Pat. No. 6,169,978 in that more than one item could be laid on the weighing plate. Items could be not only strictly postal items but even documents such as passports, guide licenses, check and money for payment of the service together with the postal item.

A further advantage of the proposed invention compared to U.S. Pat. No. 6,169,978 is that the high resolution image is heavy to manipulate and store, it is much more efficient to apply as built-in functionality and part of the device process a character recognition process: the advantage is to speed up communication and to reduce required memory for storage.

A further advantage of the proposed invention compared to U.S. Pat. No. 6,169,978 is in that image is segmented in its relevant part, i.e signature, fee, etc, and crypt thus greatly reducing the storage space.

Usually documents are written on both faces of sheets in order to spare for paper or writing supports costs and to reduce documents thickness. This is concept is not respected in the creation of image acquisition devices. New copying machines could uses a black and white single side CCD and the second sheet side image could be acquired by tilting manually the sheet or introducing a mechanism to invert sheet position upside-down. This is natural for a human reading documents, but for a machine requires the introduction of a mechanism or of a further operation in the process. In any case this mechanism/operation produces a time loss and thus a deviation from an ideal result.

The disclosed device allow a faster image document acquisition and processing since image acquisition is performed at same time if the a system is built with a processor for each image acquisition sensor or, with imperceptible time delay if single image processor for several acquisition sensor is used. In this last case lot of resources are saved since together with the spared process time device costs are reduced.

A proper light source is used to enlighten the document surface acquired by CCD sensors. This for the main reason to augment the contrast due to difference in light reflection/absorption of different colours composing documents printing. Secondly, this overcome any possible light ray passing through the document and producing a false image due to transparency. To avoid the transparency capturing of both documents faces a light obstacle is introduced in the form of cover or similar. This behaviour is in reality an obstacle to use efficiently the system to check for documents containing any kind of watermark (i.e. banknotes, stamps, stocks assignment documents, etc. This behaviour produces an other inconvenient since it is not possible to process and store efficiently together with other documents ON THE SAME DEVICE x-ray sheets and transparent used in security field requiring two devices to build a case folder.

An other further disadvantage of the existing system is that IT LIMITS the evolution of use of the x-ray or EMR documents to single side representing one section while, they could be impressed both in transparency and on each of the side for diagnosis/care comparison etc.

The disclosed device allows the acquisition and use of virtually four images:

i) a top side direct image,

ii) a bottom side direct image,

iii) a transparency top side image,

iv) and a transparency bottom side image.

Sometimes the presence of big marks, stamps, pictures, images or the thickness and opacity of the document made impossible the use of transparent view, in this case two images only are available for processing i.e. direct image as in i) and ii).

Actual copying machines requires good planarity for the documents, this produces both the need for a cover or holder to press the documents face on the image plane. This is requested since the intense light used produces easily non uniformity of image acquisition if non planar surface is presented. An other reason of this need is that the optics used has often very stiff performances, i.e. short field depth not allowing high flexibility for acquisition.

The disclosed device allow, through the careful use of optics with a good field depth coordinated with the diffuse light emission the acquisition of non planar images such as those produced by documents such as passports, certifications etc.

Usually it is required for copying two faces of the documents to have an acquisition system on one side, and a further active hardware system. The further active system is actually an upside-down tilting mechanisms that introduces possible failure as shown above. One other solution, disclosed in the present invention, uses an image acquisition device for each document surface. Nevertheless, in case where the transparency or semi-transparency phenomena are applicable (i.e. in the most of Xerox operation) it is not needed to spend the money for doubling the acquisition system or the tilting system that has its major drawbacks in the introduction of mechanical parts that introduces costs and point of possible failure.

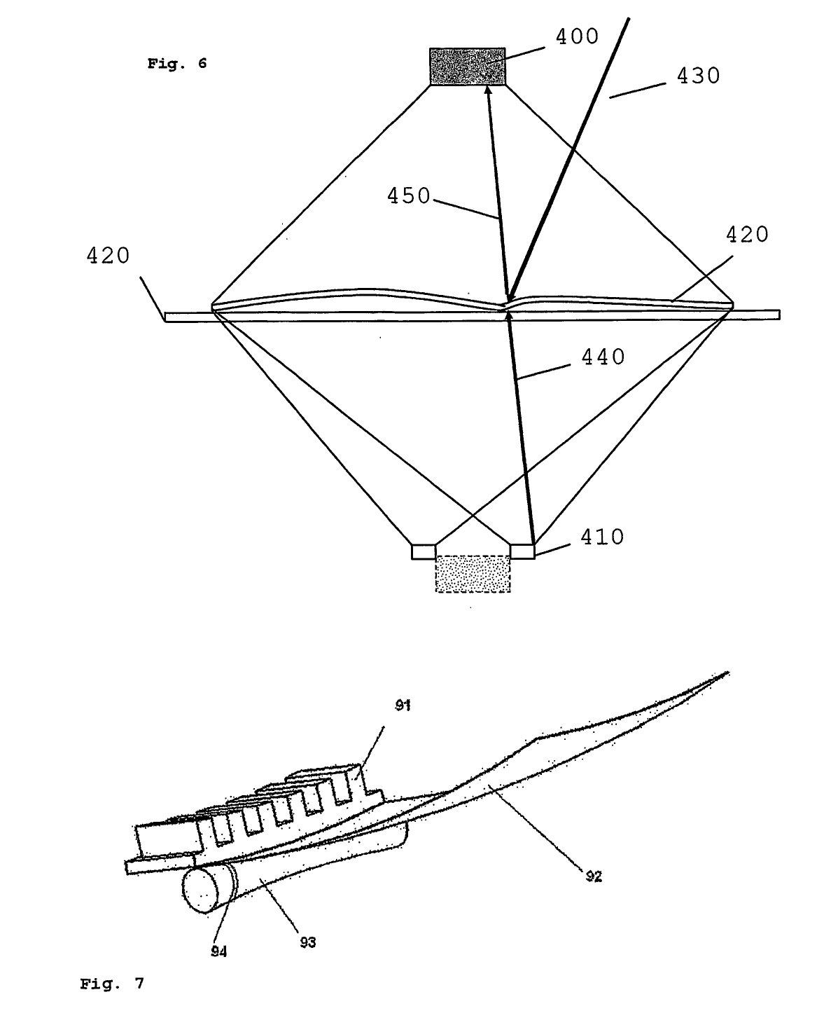

The disclosed devices allows to acquire double sided images from a single side (400) when the nature of documents (420) allow for that. The operations are performed to the following operations (see FIG. 6):
i) a direct image is acquired coming through ray 450 and generated by reflected light ray 430 of natural type or of artificial type (410),
ii) an indirect image is acquired through ray 450 and generated by pass-through light ray 440.
iii) both images are elaborated and using image processing techniques transmitted image is cleaned from direct image interference.

Usually any acquisition device used on desktop in offices has a base to support the document with a mean to reference the acquisition device to the base. In more detail, the base could be made of plastic, wood etc. with the dimension greater or equal to the maximum image to be seen. This create several shortcomings, mainly a non uniformity of the desk since the material end the geometry are varied, secondly the need to align preferentially the system to the desktop layout for design and aspect, secondly to place the system in good light condition and to modify often the desktop and light layout with an increase of the installation costs. An other shortcoming of the such a layout is that in the difficulty of moving both the image acquisition device and/or in the presenting of documents with limitations on positioning due to the holder and base layout.

The disclosed device has a built-in light source projector aligned and fixed with the image acquisition device to project light signs on the desktop to indicate dynamically and without any misalignment the acquisition area

Usually a system that generates data for transaction by image acquisition and processing communicate through the network transactional system through existing connections. This results in an increasing of traffic in two directions:
i) the traffic between an high productive device is locally great and the use of serial communication limits the system by exchange rate and protocol management,
ii) the traffic between the system and the network increases and the network performances could be affected. To solve such shortcoming usually an other device is introduced to manage the traffic and/or to create a buffer for distributing traffic in a further working phase. These are solutions that increase the installation cost and are not easily scalable to WAN and big organization.

The disclosed device includes a wireless communication system able to support at least a local alternative communication link to transfer images, transactional data etc. without charging the organization network. Wireless communication is also provided to bridge the change of network interfacing from existing one of wired type to a local, sub-area, area and global one using existing technologies such as (UMTS, GPRS, etc.)

Usually a system for image acquisition perform basic acquisition using two sub-system: a image sensitive device and a data processing unit to process raw data from sensitive device and produce image stream. In standard application each sensitive device is coupled to a processing unit, this is an optimal solution for single device acquisition but multiplying this is costly when static images or even streams need to be acquired. A further existing problem is the coordination of acquisition device including sensors through a single processor.

The disclosed device includes at least a single processor to coordinate the acquisition devices. The devices includes electronic cards with CMOS or CCD acquiring raw data stream that are processed and converted by processor with usual techniques: preferably the used format will be JPEG and PDF of compressed nature. The JPEG is transferred with each of colour planes and the composed image using a quality level suitable for OCR processing. The PDF format is created for viewing purposes, to generate together with the transaction the image of the acquired documents for further use. The disclosed device includes not only two sensors for double side documents acquisition but even further acquisition devices such as one capable of capturing customer or user picture to include in a crypt and/or anonymous mode: this is made for security and anti-terrorism purpose.

Usually image acquisition systems have single light type, the light spectral composition is fixed and change or variation is seen as a defect. Actually there is an increasing need of great variation of emitted light and thus different reflected/absorbed components could be analyzed. This solution is related to security needs.

The disclosed device includes the ability to process exclusively or integrally the colour image to identify better nature of documents from image (i.e. checks emitter, bank emitter etc.). A further advantage of the present device is the introduction of a specific light component to excite special components introduced in inks or paper such as U.V. radiation or I.R. radiation. The solution is visible for low percentage of U.V. light especially in the blue plane of the processed image.

Usually height measurement is performed for image acquisition systems through the acquisition of two images and stereoscopic processing. This produces cost increase since it requires doubling the image acquisition device or introducing a system to move it or the document.

The disclosed device use a projected light grid and edge recognition to measure dimensions in plan view. The height is measured using the grid light deformation and/or a light/dark spot protruding from a location and having a cone shape due to ray divergence. The dimensions are thus directly related to the distance of intercepting surface and spot dimension is linearly related to documents height. The proposed system is thus efficient and low cost since it uses same existing resources of the system and the whole functionality is easy to implement in the software. Alternatively in an easier way but less precise is possible to measure image of the object taken from one side and compare the measures with those taken from the other sides: the ratio of this measures multiplied by a system dependent geometrical value returns the height of the height of the object.

Usually offices manage documents; public and even private offices are sources of possible terrorist actions. The demand for economic efficiencies requires a large amount of transactions, a large amount of documents and thus the time for a proper security check is reduced. Actually does exist systems and methods for the identification of potential dangerous chemicals and bacteriological substances, they are often single functional and specialized device, requiring more time and producing often insufficient data for a correct case file generation including: picture, dimension, weight and chemical substances.

The disclosed device includes this functionality allowing following operation through a special coordinated functionalities:
i) capturing image of the customer/user asking for the transaction (if any),
ii) placing the document on the weighing surface (if any),
iii) capturing the image and processing,
iv) capturing the height,
v) air suction and analysis from the documents area,
vi) in case dangerous or tracing substance are identified the system issues alarms,
vii) alarm is issued through include wireless communication (if any) or through connection network with priority,
viii) on alarm picture, dimension and consistency of documents are spread to other existing units on escalating dimensions through local area, sub-region and regional area network.

Usually offices manage documents in a single way, especially at front desks. It is not possible to open and close transactions at the very same time and location. This is due to regulations, norms etc. etc. that state timing for the file to be processed or requires “manual” operations. Sometimes it is mandatory to acquire series of documents. The problem of feeding documents is very often solved by a traction system with single directional movement, this produces a documents flow in the system. Such a solution is good but it requires careful study of front desk and office layout thus reducing flexibility. The disclosed device includes a feeding system based either on transparent rolling strip or on air feeding or even on gravity having the characteristics of capturing the image during document free falling and processed thereof.

Especially public employees are put under stress by the number of repetitive operations they perform on not proper positioned and designed devices. Despite common knowledge the more frustrating operations deal not with physically manipulating object to be delivered, but with the boring operations to look for precise positioning and for writings and symbols placed on documents. It is evenly more frustrating to read and write data concerning about documents characteristics such as weight, stamp value etc. Queues or lines in public offices, comprising people waiting to interact with a public employee, are commonplace, and are generally disliked by all concerned. The delay in being served is a potential source of frustration and annoyance to customers. An annoyed customer may take issue with, or even threaten the public employee who he eventually meets for service.

Whilst some of the people waiting in such queues require a public employee to carry out a relatively complex and involved service, many people only require basic counter services.

A common place to all these customer are basic operation of checking the delivery, looking for information on the sides of the delivery, weighing it, rereading and inputting the information in a device etc. etc. These operations become evenly boring both to the public worker and to the customer. Accordingly, it is an other general object of the present invention to overcome or at least mitigate the problems and shortcomings associated with the public offices as identified above.

According to a first aspect of the invention there is provided an integrated multi-function desk for use in a public and private offices, comprising a processor electrically coupled to each of: an input device operable by a user, a device for weighing documents, a device for capturing image, a visual display; the processor being configured to: (a) receive input from weighing device specifying the weighing of an object placed thereon; (b) receive input from image capturing device of an object placed thereon; (c) receive input from the input device specifying other necessary characteristic of the delivery; (d) process the image information in order to recognize dimensions, writing characters and/or symbols from the electronic image captured previously; (e) provide output to the visual display to show image, dimensions, writings and all recognized characteristic from the object placed thereon; and (f) operate the output device to supply storage of retrieved information for further operations such as printing, showing, analysing etc.

Preferably the said output device is adapted to dispense the images captured from the public delivery.

Preferably the integrated multi-function desk further comprises an output device adapted to dispense a label with the elaborated data resume determined by the automatic reading and processing of image and weighing from the device.

Preferably the said output device is adapted to dispense postage stamps which value is determined by the automatic reading and processing of image and weighing from the device. Preferably the said output device is adapted to print and dispense franked postage labels which value is determined by the automatic reading and processing of image and weighing from the device.

Preferably the said output device is adapted to print and dispense a shipping label which terms are determined by the automatic reading and processing of image and weighing from the device.

Preferably the payment acceptance device comprises a cash acceptance and discrimination device.

Preferably the integrated multi-function desk further comprises an output device adapted to print and dispense a payment receipt which value is determined by the automatic reading and processing of image and weighing from the device.

Preferably the visual display is a low thickness, touch sensitive (LCD, FLCD, OLED etc.).

Particularly preferably, the processor, the input devices, the weighing system, the visual display, the payment device, and the output devices are connectable in different units within the public and private offices local or global network.

By removing the need for the employee to turn the public object, to read and digitise data such as weight, stamp values, addressee etc. it is reduced the probability of errors in expeditions and charges. The employee has the function to control the data and the customer itself, through the display unit could check and aid the employee in its simpler and more effective role of controller instead of being frustrated by not participating to the operation on its own public deliveries.

Embodiments of the invention will now be described, by way of example, and with reference to the drawings in which:

FIG. 1-2-3-4 illustrates views of an two example lay-out of integrated multi-function desk for use in a public and private offices, in accordance with the invention;

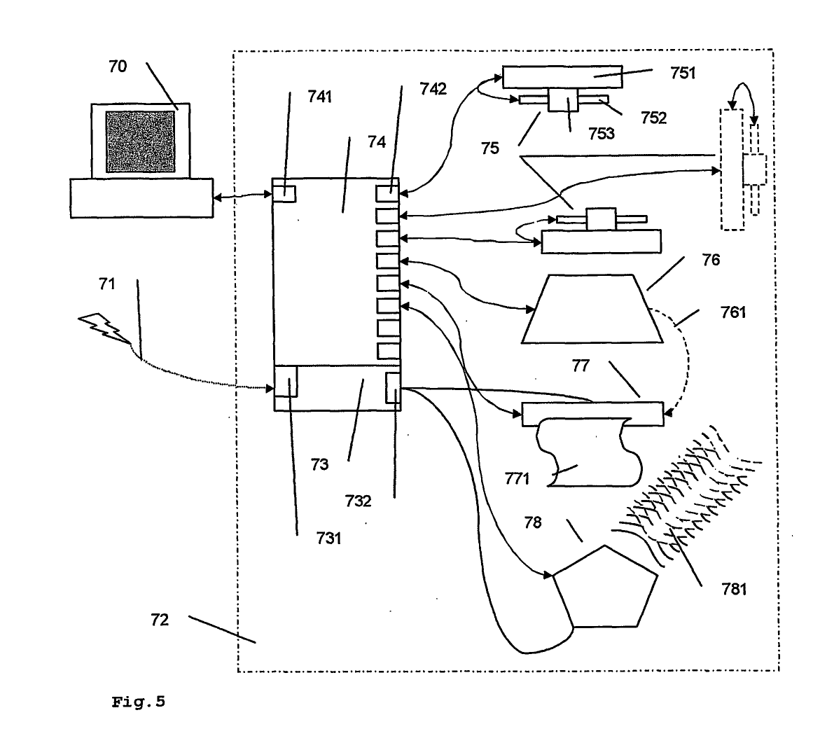

FIG. 5 is a logic and functional diagram of the integrated multi-function desk;

FIG. 6 show the transparency method of image acquisition and

FIG. 7 illustrates a specific aspect of label release to allow an easier usage of the machine by the user.

### DETAILED DESCRIPTION OF THE SCHEME AND DEVICES

The scheme is intended for the illustration of specific connection and functionalities and should be intended as example and not be a limitation for different and alternative realizations. The multifunction device (72) is connected via a communication channel to a computer (70) and to the power supply (71).

Sub-system (74) is a communication device of hub type allowing the communication from and to the computer processor. The device is of high speed type, with a specific internal capability to manage without downgrading its speed performances, to transmit both from low speed peripherals (i.e. printing system) and high speed peripherals (i.e. image streaming). The system (74) has an external communication channel (741) and a series of internal communication channels (742). Integrated to the system (74) an other sub-system (73) take care of power supply; it is specifically designed to supply power to sub-system (74) and to supply power to the other devices. In a specific realization of the system the device (74) supply two tension of 5V and 24V to the communication system and to the printer, weighing system etc. The system has a power input (731) and a series of connectors (732) to supply the transformed and conditioned power.

One of the sub-system for image acquisition (75) is connected to the system, sub-system (751) capture, process and transmit image data, sub-system (752) perform the lighting and the light balance according to the previous description. The optical component (753) is designed according to the need of image depth, width and focal height and light type (U.V., white or coloured light).

Sub-system (76) is a weighing system, preferably of the extensimeter type and with a plane transparent to light or electric and magnetic fields. According to regulations the weighing system transmit the weight to the computer and to the printer unit via special link (761). The link connects the sub-system (76) with the printer system (77) in order to print a ticket, label or document (771). The information such as images, weight, dimensions, text etc. could be transmitted through the ordinary network or in alternative way through an internal communication device (78) preferably of the wireless type using field (781) for transmission.

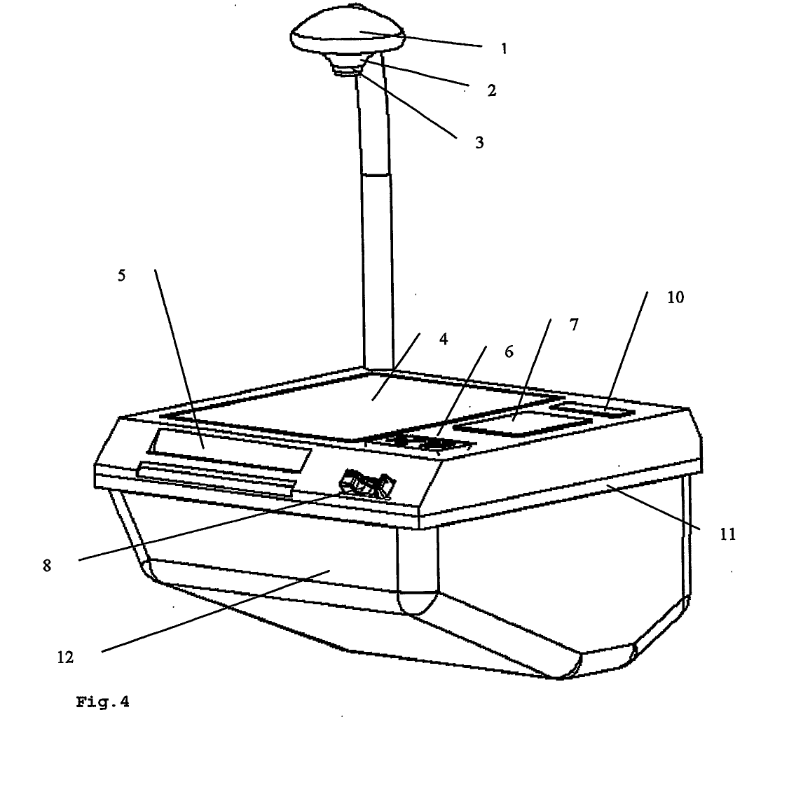

In FIG. 1, FIG. 2, FIG. 3 and FIG. 4 are represented two possible layouts of the system realized with a static image capturing system, the choice to realize the device using a movable image capturing is related to service life considerations. Being a built in like block with local or remote electronics the proposed system is much more effective in MTBF parameters both for the MTBF of components and for the reduction in component number.

The image could be captured and procedure internal to the system, using image processing technology (and three color planes if necessary) calculates blob areas for different documents and their positioning relative to references allowing for sub-area alignment with reference axis of the device for each blob in the image.

In FIG. 1-2-3 a specific embodiment of the device is shown according to a full integration in furniture or frame together with ancillary devices such as the computer and paper documents printers. The present embodiment is given for better illustrating the realization of the system and it is not intended as limiting in any way the extent of the application especially for different shape and assemblies of the components to perform same final functions.

FIG. 1 illustrates a schematic view of the system with the enclosure or furniture (4) holding and referring an image acquisition and lighting device (1), a weight measuring device (2) a movable cover to access internal of the multi-functional device especially for the label/document printer (3), internal parts and electronics. The enclosure/furniture is designed to support any other useful device such as computer (6), printers (5) etc.

In FIG. 2 a side section view of the system is given for more clarity.

The upper case contains electronic cards and optical elements for the acquisition of image, lighting and transmission to the internal hub (8). A similar assemblies is contained inside the device, in this case optical device could be different to reduce required space (10). A plane for weighing (9) separates upper and lower volumes and the weighing elements are supported by frame (11) that holds all other devices such as printer/label printer frame (7) and any other electronic card and mechanical device is contained in the inner volume (10bis). The section view of FIG. 3 illustrates the label printer lay-out (12) and the lower light diffuser (13), in front view. One of the main advantages of the disclosed device is to integrate functionalities preserving easy of use, ergonomics and preventing proliferation of peripherals on the employee desktop.

In FIG. 4 an other embodiment of the multifunction device is illustrated. The system performs same basic function of the system shown in FIG. 5 and some extended functionality is added.

The vision/light optical holder (1) integrates electronic cards, light diffuser (2) and optical system (3). A reference plane (4) activates a switch (or even the weighing system acts as a switch) allowing image capturing.

The inlet and outlet 5 of a document printer (preferably A4 format) is in the front part of the multi-function device.

A simple display (6) compliant to regulation and laws is inserted flat or wedged on the top device together with a programmable touch screen (7) and external plugs for remote ancillaries (such as repetition display or user camera) and push buttons (10). In the front portion a card reader of simple or mixed type (8) is inserted, too.

A frame (11) supports all devices and the lower case (12) allowing for closed volumes for electronic cards etc. etc.

The system communication for both mechanical designs (FIG. 1-2-3 and FIG. 4) is allowed through an hub system collecting al the internal unit with specific functionalities. For the purpose of the system the hub is self powered and has the inner power conversion, connection and plugs to issue power to printers, lights, card reader etc. etc.

This allows for a great spare in components costs and in the ability to manage at a low level communications between internal subsystems, especially when performances conflicts appear such as procedure dead-locking and communication speed down-grading.

An other specific system included in the device is the light intensity regulation piloted by independently for upper an lower light system. Each of the system having internal control capability to set illumination level from a minimum value to a maximum value. Both values could be stored and used according to the chosen acquisition sequence. The triggering point be the neutralization of all great part of all of the single sheet transmitted light.

With such a remote light control the system could switch from a stand-by value to an acquisition value and upon a further analysis change according to environmental and document conditions the lighting intensity level to meet the image quality performance.

Moreover the increase of usability of the system requires to avoid the problem due to shocks and unattended loading of weighing plate that has been solved by introducing inside extensimeter element especially designed in order to have internal mechanical overload stopper obtained by specific working of the load cell.

Moreover the increase of usability could been obtained by new careful design of printing head for label, sticks and electronic stamps according to FIG. 7. The head (91) is bend transversally to the direction of label (92) movement travelling (see FIG. 7). A support roll (93) push the roll against head for optimal printing.

The head and relative roll could be even flat as in known art having at least a roll or a series of rolls bending the paper after printing phase.

In such conditions the printable length could be largely increased; moreover the preparation of surfaces hosting the printed label is less costly to be realize and the user can manipulate the label without usual shortcoming unwanted sticking, bending etc.

The supporting roll could have even a slot (94) reducing the diameter in a portion of the roll length to allow the printing of label containing a RFID. The printing and use of such label is allowed by the presence of the working plane transparent to EM waves of the type useful to read and program the RFID memory and/or identifier number. The silicon integrated circuitry has a thickness able to reduce pressure of the printing head producing a printing defect; in such a situation the slot is useful to create a passage for the over thickness increase.

1-37. (canceled)

38. An automated multi-function desk for use in a offices in order to evaluate documents parameters, comprising a furniture holding with a frame for supporting:—a device for weighing the documents with a plane transparent to light;
means for keeping said documents parameters available for further uses on said plane, comprising means for evaluating dimensions of the documents, a device for capturing an image for each item side consisting of two CMOS sensors able to acquire raw data stream, and positioned above and below the transparent plane (claim 34) without movable parts and without tilting and flattening the documents and a processor for elaborate the documents parameters connected with said device for weighing the documents, said means for evaluating dimensions of the documents; said means for keeping said documents parameters available for further uses.

39. A device as claimed in claim 38 where said device for capturing an image for each item side is a solid state CCD data acquisition system instead a CMOS, and it is disposed on both side of the document able to acquire raw data stream.

40. A device as claimed in claim 39 where said raw data stream are processed by said processor.

41. A device as claimed in claim 38 where said raw data stream are converted by said processor in JPEG and PDF.

42. A device as claimed in claim 38 where said plane transparent to light acts as a switch allowing image capturing.

43. A device as claimed in claim 38 where said plane transparent to light is also transparent to electric and magnetic fields, ultraviolet light or infrared light.

44. A device as claimed in claim 38 which comprises a variable light system to enlighten both surfaces of the documents, that is regulated by said means for keeping said documents parameters.

45. A device as claimed in claim 38 where the weight signal is transferred and memorized inside a printer without passing through said processor.
